(19) United States
(12) Patent Application Publication
(10) Pub. No.: US 2003/0084163 A1
(43) Pub. Date: May 1, 2003

(54) Establishing wireless connections

(76) Inventor: Steven Wang, Portland, OR (US)

Correspondence Address: TROP PRUNER & HU, PC, 8554 KATY FREEWAY, SUITE 100, HOUSTON, TX, 77024, US

(21) Appl. No.: 10/020,702

(22) Filed: Oct. 30, 2001

(51) Int. Cl. G06F 15/16

(52) U.S. Cl. 709/227; 709/237

(57) ABSTRACT

A consumer and a cableless provider may quickly establish connections with one another by setting up certain profiles within the consumer. When the cableless provider is identified, the profiles stored within the consumer may be utilized to quickly establish a communication protocol without the need to repeatedly exchange this information between the consumer and cableless provider. As a result, communications may be established more quickly, saving time and reducing power consumption.

### BACKGROUND

This invention relates generally to wireless communication protocols and, particularly, to connection establishment in wireless communication protocols.

One widely adopted communication protocol is the Bluetooth Specification (Specification of the Bluetooth System, Version 1.1, Feb. 22, 2001). The Bluetooth Specification involves 2.4 gigahertz signals over the Instrumentation Scientific and Medical band. The signals have a ten meter range, but may be extended to one hundred meters.

A device coming into a Bluetooth piconet may enter the inquiry mode. The device, upon reaching the new environment, initiates an inquiry to find out what access points are available within its range. Any in-range access points respond with their addresses and the device may eventually pick out a responding access point with which to establish communication.

The device then begins the paging protocol. Paging enables the initiating device and the access point to synchronize in terms of clock offset and phase in the frequency hop, for example. Thereafter, the link management protocol (LMP) establishes a link with the access point. In the course of establishing a link, a responding slave or non-initiating device may ask for a role switch with the access point in some cases. The access point then responds with the appropriate packet accepting (or not accepting) the role switch request.

The device that starts the paging procedure is generally called the master and remains the master of the piconet consisting of itself and the paged device, if the paged device accepts the connection. However, before starting actual data communication, the master and slave devices may exchange roles.

In some cases, access is restricted by particular access points to particular types or groups of users. To enforce the access restriction, an access point may send a security request for pairing. In order to be paired, the device seeking access must provide a code, such as a personal information number (PIN) to access the service. If a secure mode is being utilized for communications, encryption may also be invoked.

In a number of cases, the establishment of a connection tends to be somewhat onerous. In devices that repeatedly seek to communicate with one another in a rapid fashion, these connection establishment protocols may tend to bog down the operation of devices in such circumstances. For example, when using a keyboard, mouse or printer that communicates over a wireless protocol with a personal computer, a number of high-speed communications may be needed. Many of the involved devices may also be battery powered. Completing the extended connection establishment protocol with each communication, results in unnecessary time delays and increased power consumption.

Thus, where one device frequently wirelessly communicates with another device, there is a need for better ways to enable connections using wireless protocols.

### BRIEF OF THE DRAWINGS

FIG. 1 is a schematic depiction of one embodiment of the present invention;

FIG. 2 is a flow chart for software in accordance with one embodiment of the present invention;

FIG. 3 is a flow chart for software in accordance with another embodiment of the present invention; and

FIG. 4 is a flow chart for setup software in accordance with one embodiment of the present invention.

### DETAILED DESCRIPTION

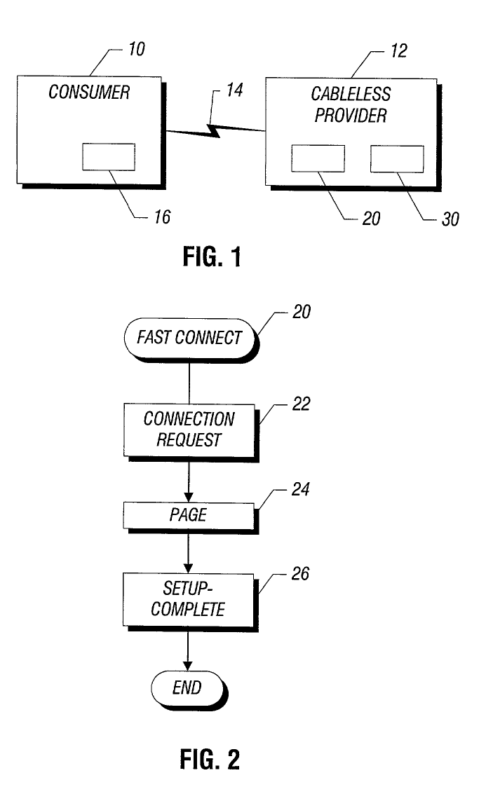

Referring to FIG. 1, two devices 10 and 12 may implement a wireless communication protocol 14 to exchange information. In one embodiment, the device 10 may be called a consumer, because it needs a service from another device called a provider device 12. Conventionally, the consumer device 10 may be coupled by a cable to the provider device 12. However, by using a wireless communication protocol, the devices 10 and 12 may communicate without the need to physically connect the two devices 10 and 12.

The cableless provider device 12 may be a wireless mouse or keyboard, to mention a few examples. Typical consumer devices 10 include laptop computers, desktop computers, and handheld processor-based devices, again to mention only a few examples.

A cableless provider device 12 needs to be connected to the consumer device 10 without increasing the time needed to establish a link as well as power consumed in establishing a link. In such transactions, the consumer device 10 may always be designated as the master device.

Cableless provider devices 12 may be identified by an indication bit. For example, class of device field in an FHS packet may be utilized to identify cableless provider devices 12. An FHS packet is a special control packet revealing the Bluetooth device address and the clock of the sender. The FHS packet includes eleven fields including a 24 bit class of device field. See Bluetooth specification, version 1.1 at p. 56.

The consumer device 10 may maintain profiles or profile types for cableless provider devices 12. Different types of cableless provider devices 12 may be assigned identifiers. Certain characteristics of the cableless provider device 12 necessary to establish a link connection may be stored on the consumer device 10 (and vice versa) so that it is not necessary for the cableless provider device 12 (or the consumer device 10) to provide that information during the connection establishment protocol.

Instead, a communications initiating cableless provider device 12 may simply identify itself as a cableless provider, provide its profile identifier, and the consumer device 10 may have sufficient information to begin the establishment of a link. Alternatively, where the consumer device 10 initiates the communication it may already have the information needed to connect with the selected provider device 12. For example, the consumer device 10 may store the address and packet type information of each cableless provider device 12 or of each type of cableless provider device 12. Pairing and authentication may be eliminated to speed the fast connection when the device seeking to establish the connection or the device to which a connection is being made is a cableless provider device 12.

Thus, referring to FIG. 2, when a cableless provider device 12 is the target of a communication, a fast connect protocol 20 may be utilized. It may begin with a connection request, as indicated in block 22. The connection request may come from the consumer device 10 seeking to provide information to the cableless provider device 12 or from the cableless provider device 12 seeking information from the consumer device 10. In the course of the connection request, the fact that the communication involves a cableless provider device 12 may be determined. For example, the consumer device 10 may know that the data transmission is directed to a cableless provider device 12. Conversely, if the cableless provider device 12 is initiating the communication, it may identify itself as a cableless provider device 12 to the consumer device 10. In such case, the consumer device 10 automatically acquires the stored profile for the subject cableless provider device 12. Using this profile, the consumer device 10 can establish the connection without the need to exchange identity information with the cableless provider device 12.

Moreover, the consumer device 10 always assumes the master role in any communication with a cableless provider device 12. These master/slave assignments may be preprogrammed into the devices 10 and 12.

In response to a connection request, as indicated in block 22, the consumer and cableless provider devices 10 and 12 may implement a page mode, as indicated in block 24, in which the consumer device 10 is always the master device. Once the page mode has been completed, the setup and establishment of the communication channel may be completed, as indicated in block 26.

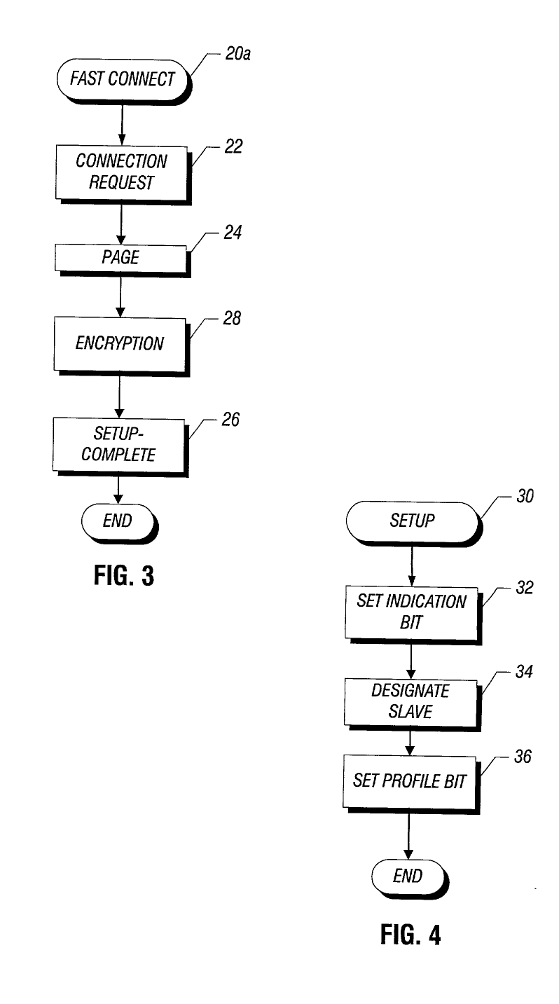

Referring to FIG. 3, in accordance with another embodiment of the present invention, an encryption step 28 may be included if desired. Thus, encryption may be completed after paging in some embodiments.

In the case of the fast connect protocol 20 or the modified fast connect protocol 20a, unnecessary operations including role changes, pairing and authentication may be eliminated in order to speed the connection process.

Referring finally to FIG. 4, in order to setup a cableless provider device 12 for communication with a consumer device 10, a consumer device 10 may provide the cableless provider device 12 with an indication bit that identifies the cableless provider device 12 as a cableless provider, as indicated in block 32. The cableless provider device 12 may thereafter accept the role of being a slave device, this information having been programmed into the cableless provider device 12, as indicated in block 34. In addition, the cableless provider device 12 may have a profile bit that identifies the type of cableless provider and includes information such as the address, packet type, and the like, needed to establish a communication protocol, as indicated in block 36.

Any information needed to establish the connection is exchanged on the establishment of the first connection. Thereafter upon learning of a device's identity, its profile may be automatically called up. Each device's master/slave status is also predetermined.

Basically, the flow 30 may be implemented either in the consumer device 10 for the benefit of one or more provider devices 12, or in the cableless provider devices 12 themselves.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
establishing a wireless connection between a cableless provider and a consumer; and
using pre-exchanged information in order to avoid the need to exchange information each time a connection is established.

2. The method of claim 1 including exchanging information upon the first connection between a given cableless provider and a consumer.

3. The method of claim 2 including storing information in order to avoid the need to exchange information each time a connection is established.

4. The method of claim 1 including denominating said consumer as the master device and said cableless provider as slave device.

5. The method of claim 4 including programming said consumer to always be the master device.

6. The method of claim 1 including enabling a Bluetooth connection.

7. The method of claim 6 including enabling a Bluetooth connection between said consumer and said cableless provider without providing for authentication.

8. The method of claim 7 including enabling a connection between the cableless provider and the consumer without providing for pairing.

9. The method of claim 1 including providing an indication bit that identifies the cableless provider to establish a connection.

10. The method of claim 9 including providing information to a consumer from a cableless provider that indicates the type of device of the cableless provider.

11. An article comprising a medium storing instructions to enable a processor-based system to:
establish a wireless connection between a cableless provider and a consumer; and
use pre-exchanged information in order to avoid the need to exchange information each time a connection is established.

12. The article of claim 11 further storing instructions to enable processor-based system to exchange information upon the first connection between a given cableless provider and a consumer.

13. The article of claim 12 further storing instructions to enable processor-based system to store information in order to avoid the need to exchange information each time a connection is established.

14. The article of claim 11 further storing instructions to enable processor-based system to denominate said consumer as the master device and said cableless provider as slave device.

15. The article of claim 14 further storing instructions to enable processor-based system to program said consumer to always be the master device.

16. The article of claim 11 further storing instructions to enable processor-based system to enable a Bluetooth connection.

17. The article of claim 16 further storing instructions to enable processor-based system to enable a Bluetooth connection between said consumer and said cableless provider without authentication.

18. The article of claim 17 further storing instructions to enable processor-based system to enable a connection between the cableless provider and the consumer without pairing.

19. The article of claim 11 further storing instructions to enable processor-based system to provide an indication bit that identifies the cableless provider to establish a connection.

20. The article of claim 19 further storing instructions to enable processor-based system to provide information to a consumer from a cableless provider that indicates the type of device of the cableless provider.

21. A wireless device comprising:
a controller; and
a storage storing instructions that enable the controller to establish a wireless connection and use pre-exchanged information in order to avoid the need to exchange information each time a connection is established.

22. The device of claim 21 wherein said device is a cableless provider.

23. The device of claim 21 wherein said device is a consumer.

24. The device of claim 21 wherein said device operates at 2.4 gigahertz at a range of approximately ten meters.

25. The device of claim 21 wherein said device does not provide for authentication.

26. The device of claim 21 wherein said device does not provide for pairing.

27. The device of claim 21, said memory storing instructions that enable the device to provide an indication bit that identifies the device to establish a connection.

28. The device of claim 27 wherein said device identifies itself through an FHS packet.

29. The device of claim 27 wherein said device indicates its device type.

30. The device of claim 21 wherein said device is always the master.
